(19) United States
(12) Patent Application Publication
(10) Pub. No.: US 2018/0052263 A1
(43) Pub. Date: Feb. 22, 2018

(54) PRIVACY FILTER

(71) Applicant: CORNING INCORPORATED, CORNING, NY (US)

(72) Inventors: Hsichieh Chen, Taipei City (TW); Jr-Nan Hu, New Taipei City (TW); Yawei Sun, Elmira, NY (US); Shoou-yu Tang, Fort Collins, CO (US); Bor Kai Wang, New Taipei City (TW)

(21) Appl. No.: 15/554,831

(22) PCT Filed: Mar. 2, 2016
(86) PCT No.: PCT/US16/20320

§ 371 Date: Aug. 31, 2017

Related U.S. Application Data
(60) Provisional application No. 62/127,360, filed on Mar. 3, 2015.

(51) Int. Cl. G02B 5/23; G02B 5/00

(52) U.S. Cl. CPC G02B 5/23; G02B 2207/123; G02B 5/003

(57) ABSTRACT

A louver structure is formed in a layer on a transparent substrate or embedded in the photosensitive substrate to form a privacy filter. The louver structure is made of an alternating arrangement of non-transparent strip elements and transparent strip elements or spaces. The louver structure is created by mask and actinic radiation, which can enable mass production and a short lead-time.

### CROSS-REFERENCE TO RELATED APPLICATIONS

This application claims the benefit of priority under 35 U.S.C. §119 of U.S. Provisional Application Ser. No. 62/127,360 filed on Mar. 3, 2015 the content of which is relied upon and incorporated herein by reference in its entirety.

### BACKGROUND

Privacy filters, also known as light control films, are devices that can be placed between a viewer and an image plane to limit the viewing angle of the image plane. Privacy filters typically include a louver film made of alternating transmissive regions and absorptive regions. The louver film may be laminated, or otherwise attached, to a base substrate. Typically, the louver film is made of polyethylene terephthalate (PET) or polycarbonate (PC). Hard coatings may be applied to the louver film for protection, but hard coatings are easily scratched.

### SUMMARY

Privacy filters suitable for use in touch panels or as screen protectors or in architectural applications are disclosed herein. The privacy filters are made out of durable materials and using methods that can enable mass production and short lead-time.

In one embodiment, a privacy filter includes a transparent substrate and a louver structured formed in a layer on the transparent substrate. The louver structure includes a plurality of first strip elements and a plurality of second strip elements in alternating arrangement on the transparent substrate. The first strip elements are made of a non-transparent thermally irreversible photochromic polymer, and the second strip elements are made of a transparent thermally irreversible photochromic polymer.

In another embodiment, a privacy filter includes a transparent substrate and a louver structure formed in a layer on the transparent substrate, where the louver structure includes a plurality of parallel, spaced-apart non-transparent strip elements, where each non-transparent strip element is made of cured ink.

In another embodiment, a privacy filter includes a photosensitive transparent substrate having a louver structure embedded therein. The louver structure is defined by an alternating arrangement of a plurality of non-transparent strip areas and a plurality of transparent strip areas of the photosensitive substrate.

It is to be understood that both the foregoing summary and the following detailed description are exemplary and are intended to provide an overview or framework for understanding the nature and character of the invention as it is claimed. The accompanying drawings are included to provide a further understanding of the embodiments and are incorporated in and constitute a part of this specification.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1A shows a privacy filter including a louver structure formed in an irreversible photochromic polymer layer on a surface of a transparent substrate.

FIG. 1B shows the louver structure of FIG. 1A with louver elements having slanted side walls oriented in the same direction.

FIG. 1C shows the louver structure of FIG. 1A with louver elements having slanted sides oriented in opposite directions.

FIG. 1D shows viewing range and dimensions of a louver structure.

FIGS. 2A and 2B illustrate a method of forming the privacy filter of FIG. 1A according to one embodiment.

FIG. 3 shows a privacy filter according to another embodiment.

FIGS. 4A and 4B illustrate a method of forming the privacy filter of FIG. 3.

FIG. 5 shows a privacy filter according to yet another embodiment.

FIG. 6 illustrates a method of forming the privacy filter of FIG. 5.

FIG. 7 shows the privacy filter of FIG. 5 with a mounting adhesive layer.

FIG. 8 shows a privacy filter with stacked micro-structures having orthogonally aligned louver elements.

FIG. 9A shows a privacy filter as an add-on glass protector for a handheld device according to one embodiment.

FIG. 9B shows a privacy filter integrated into a case for a handheld device according to another embodiment.

FIG. 9C shows a handheld device with a privacy filter cover glass according to another embodiment.

### DETAILED DESCRIPTION

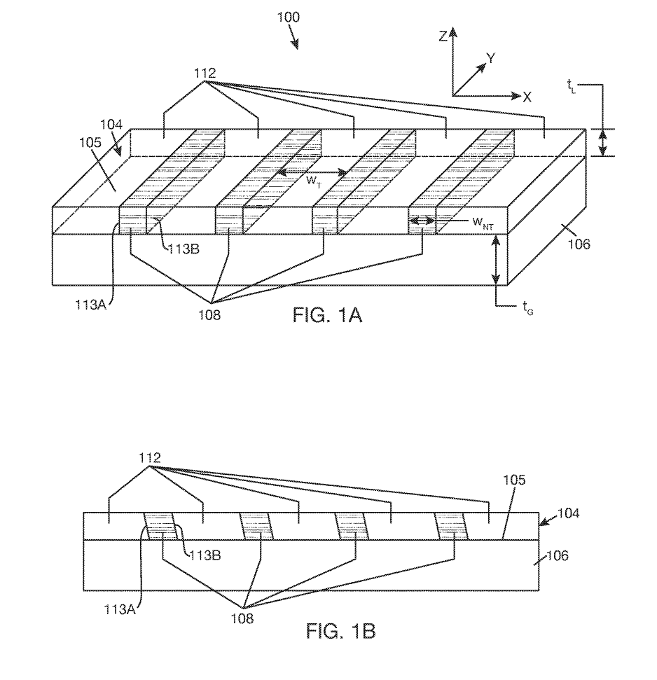

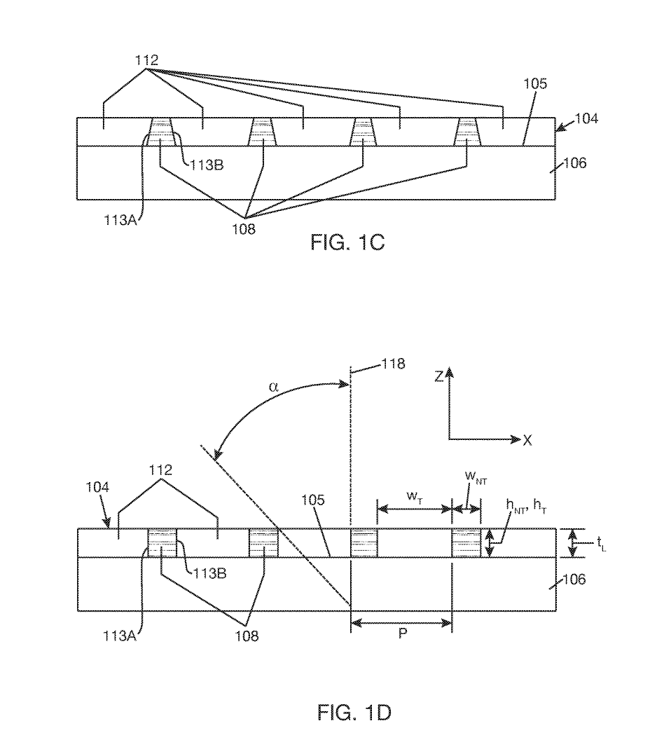

FIG. 1A shows a privacy filter 100 according to one embodiment. The privacy filter 100 includes a louver structure 104 formed as a layer on a surface 105 of a transparent substrate 106. The transparent substrate 106 may be a planar substrate, with the surface 105 lying in the X-Y plane. In one embodiment, the transparent substrate 106 may have a thickness t_{G} in a range from about 0.1 mm to about 2 mm. In one embodiment, the louver structure 104 may have a layer thickness t_{L} in a range from about 20 μm to about 200 μm. The louver structure 104 includes a plurality of non-transparent strip elements 108 and a plurality of transparent strip elements 112 in parallel alternating arrangement. The strip elements 108, 112 extend across a dimension of the surface 105, such as the dimension along the Y axis. In the parallel alternating arrangement, the non-transparent strip elements 108 and transparent strip elements 112 are parallel to each other, with a transparent strip element 112 being wedged between each adjacent pair of spaced-apart non-transparent strip elements 108, or vice versa. It should be noted that the louver structure 104 will typically have many more strip elements 108, 112 than shown in FIG. 1A, as many as are needed to form a privacy filter 100 of a desired dimension.

In the privacy filter 100 and other privacy filters that will be subsequently described herein, what is considered to be transparent or non-transparent may be defined in terms of some cutoff transmission T_{c}. If a strip element or substrate has a transmission of at least T_{c}, the strip element or substrate may be considered to be transparent. On the other hand, if the strip element or substrate has a transmission less than T_{c}, the strip element or substrate may be considered to be non-transparent. Thus non-transparent can mean translucent or opaque. In one embodiment, the cutoff transmission T_{c} is 80% in a visible range of 390 to 700 nm. The material for transparent substrate 106 can include, but is not limited to, glass, fused silica, synthetic quartz, glass-ceramic, ceramic, or a crystalline material such as sapphire. In some embodiments, the transparent substrate 106 can be glass, and the glass can be chemically strengthened, for example by an ion exchange process in which ions in the surface layer of the glass are replaced by larger ions having the same valence or oxidation state. In one particular embodiment, the ions in the surface layer and the larger ions are monovalent alkali metal cations, such as Li⁺ (when present in the glass), Na⁺, K⁺, Rb⁺, and Cs⁺. Thus, for example, Na⁺ present in the glass may be replaced with the larger K⁺ ions. The ion-exchange process creates a compressive stress at the surfaces of the glass article or glass substrate sheet. These compressive stresses extend beneath the surface of the glass article or glass substrate sheet to a certain depth, referred to as the depth of layer (DOL). The compressive stresses are balanced by a layer of tensile stresses (referred to as central tension) such that the net stress in the glass article or glass substrate sheet is zero. The formation of compressive stresses at the surface of the shaped glass article makes the glass strong and resistant to mechanical damage and, as such, mitigates failure of the shaped glass article for flaws which do not extend through the depth of layer.

In FIG. 1A, the interface walls 113A, 113B between each non-transparent strip element 108 and adjacent transparent strip elements 112 are straight. FIG. 1B shows an alternative structure where the interface walls 113A, 113B are slanted, relative to the transparent substrate surface 105, in the same direction. FIG. 1C shows another example where the interface walls 113A, 113B are slanted, relative to the transparent substrate 105, in opposite directions. The angles between the interface walls 113A, 113B and the transparent substrate surface 105 can be design variables.

FIG. 1D shows that each non-transparent strip element 108 may have a width w_{NT} and a height h_{NT} and that each transparent strip element 112 may have a width w_{T} and height h_{T}. If the interface walls 113A, 113B are slanted as shown in FIG. 1B or 1C, the widths of the elements 108, 112 along the heights of the elements may vary. The combined width of a non-transparent strip element 108 and an adjacent transparent strip element 112 may be regarded as the pitch P of the louver structure 104. Typically, the pitch P will be constant across the louver structure 104. In some embodiments, the height h_{NT} of the non-transparent strip element 108 and the height h_{T} of the transparent strip element 112 may be the same. The height h_{NT} of the non-transparent strip element 108 and the height h_{T} of the transparent element 112 may be the same as the layer thickness t_{L} of the louver structure 104, or in some cases may be smaller than the layer thickness of the louver structure.

The dimensions of the louver elements 108, 112, as explained above, can be selected to achieve a desired viewing angle of the privacy filter 100. The viewing angle is the angle within which an image on an image plane being viewed through the privacy filter is clear and undistorted. FIG. 1D illustrates a viewing angle of a degrees for a privacy filter. The viewing angle is measured relative to a normal viewing direction 118, which is a direction normal to the transparent substrate surface 105. A viewing angle of a degrees means that the image viewed through the privacy filter 100 should be clear and undistorted when viewed at a degrees or less from the normal viewing direction 118. Outside of the viewing angle, the image will be blocked and unreadable because the viewing direction will land on the non-transparent strip elements 108 rather than within the transparent strip elements 112. The viewing angle is a design variable and depends on the dimensions and material properties of the louver elements 108, 112. One example of a viewing angle is 30°.

The aperture ratio A of the louver structure 104 can be determined from Equation (1) below, where W_{T} is the width of the transparent strip element 112 and w_{NT} is the width of the non-transparent strip element 108.

$$A = \frac{{w}_{T}}{{w}_{T} + {w}_{NT}} \qquad ( 1 )$$

Aperture ratio can provide a measure of how much light is passing through the privacy filter since the light will be selectively blocked by the non-transparent areas of the privacy filter. In one embodiment, the aperture ratio of the louver structure 104 may be 50% or greater to prevent significant reduction in image resolution when an image plane is viewed through the privacy filter 100 within the viewing angle. In one embodiment, the non-transparent strip elements 108 in the louver structure 104 may each have a width in a range from about 1 μm to about 30 μm, and the transparent strip elements in the louver structure 104 may each have a width in a range from about 50 μm to about 150 μm. As an example, an aperture ratio of 80% may be achieved by selecting the width of each non-transparent strip element 108 as 10 μm and the width of each transparent strip element 112 as 40 μm (corresponding to a pitch P of 50 μm).

In one embodiment, the louver structure 104 is made from a thermally irreversible photochromic polymer that is selectively exposed to actinic radiation, such as UV light, to form the parallel alternating pattern of non-transparent strip elements 108 and transparent strip elements 112. The term “thermally irreversible photochromic polymer” is intended to refer to a polymer that has thermally irreversible photochromic properties. When such a material is exposed to actinic radiation such as UV light, it will undergo an irreversible color change. If the starting material is a transparent thermally irreversible photochromic polymer, the areas of the material exposed to actinic radiation will experience irreversible color change and become irreversibly non-transparent. The unexposed areas of the material will remain transparent. As noted above, transparent substrate 106 may be made of any transparent materials having the desirable properties for the intended application of the privacy filter 100. Also, as noted above, in some embodiments, the transparent substrate 106 may be made of a chemically-strengthened glass, resulting in a privacy filter 100 with sufficient toughness and scratch-resistance for use as screen protector.

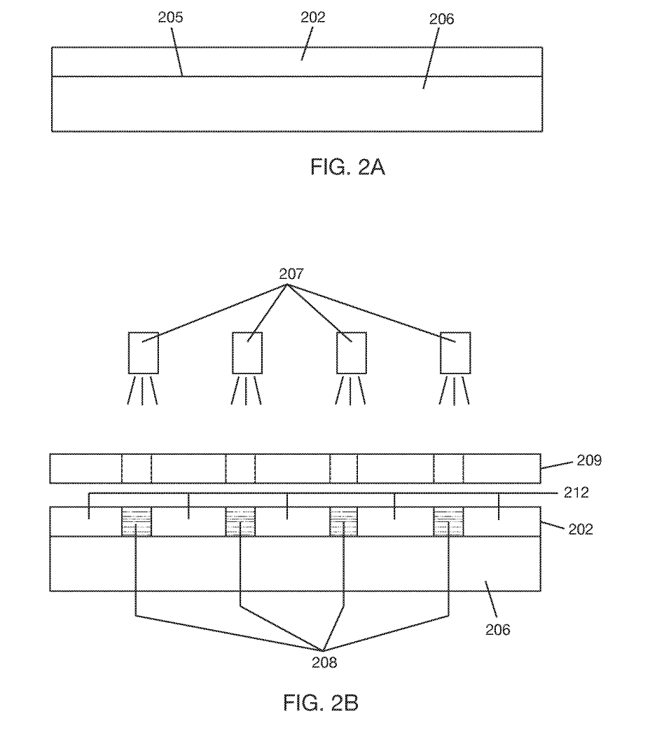

FIGS. 2A and 2B show a method of making the privacy filter 100 according to one embodiment. In FIG. 2A, the method includes depositing a transparent thermally irreversible photochromic polymer layer 202 on a surface 205 of a transparent substrate 206 (corresponding to 106 in FIG. 1A). Examples of suitable thermally photochromic polymers are thermally irreversible spiropyrans, spirooxazines, diarylethene, azobenzene, phenoxy-naphthacenequinone, fulgimide, thioindigo, dithizonate, and dihydroindolizine photochromic compounds. The transparent thermally irreversible photochromic polymer may be deposited on the transparent substrate surface 205 by spraying, slitting, spinning, or other suitable film deposition processes to form the layer 202. Alternatively, the transparent thermally irreversible photochromic polymer may be provided in the form of a film sheet that can be laminated to the transparent substrate surface 205 to form the layer 202.

In FIG. 2B, the method includes forming a louver structure in the transparent thermally irreversible photochromic material layer 202 by selective exposure of the transparent thermally irreversible photochromic material layer 202 to radiation from UV light sources 207 through a patterning mask 209. The areas 208 of the transparent thermally irreversible photochromic layer exposed to the UV light will irreversibly change color and become irreversibly non-transparent, forming the non-transparent strip elements of the louver structure (corresponding to 108 in FIG. 1A). The areas 212 of the transparent thermally irreversible photochromic layer not exposed to the UV light will provide the transparent strip elements (corresponding to 112 in FIG. 1A) of the louver structure.

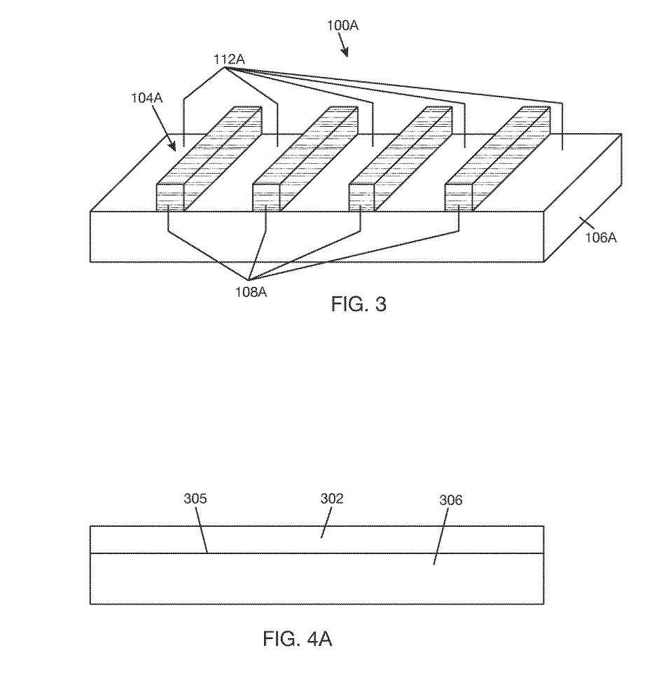

FIG. 3 shows a privacy filter 100A according to another embodiment. The privacy filter 100A includes a louver structure 104A formed as a layer on a surface of a transparent substrate 106A. The louver structure 104A includes a plurality of non-transparent strip elements 108A and a plurality of transparent channel elements (or spaces) 112A in parallel alternating arrangement. The strip elements 108A are spaced apart, by the transparent channel elements 112A, and parallel to each other. The discussion above with respect to the louver structure 104 applies to the louver structure 104A. The transparent channel elements 112A, which are spaces, of the louver structure 104A correspond to the transparent strip elements 112 of the louver structure 104 (FIGS. 1A-1D). The strip elements 108A may in one embodiment have a height in a range from about 20 μm to 200 μm and a width in a range from 1 μm to 30 μm. The transparent channel elements (spaces) 112A may have a width in a range from 50 μm to 150 μm.

The transparent substrate 106A may have the same characteristics as described above for the transparent substrate 106. In one embodiment, the non-transparent strip elements 108A are made of cured ink, which will be non-transparent. The curable ink used in the non-transparent strip elements 108A would generally include pigment(s) and resin(s) and may further include additives to formulate the ink with a desired rheology and stability. The curable ink may be selected from curable decorative and printing (inkjet or screen printing) inks. The pigment in the ink may be derived from various sources. For example, the pigment for curable black ink may be carbon black.

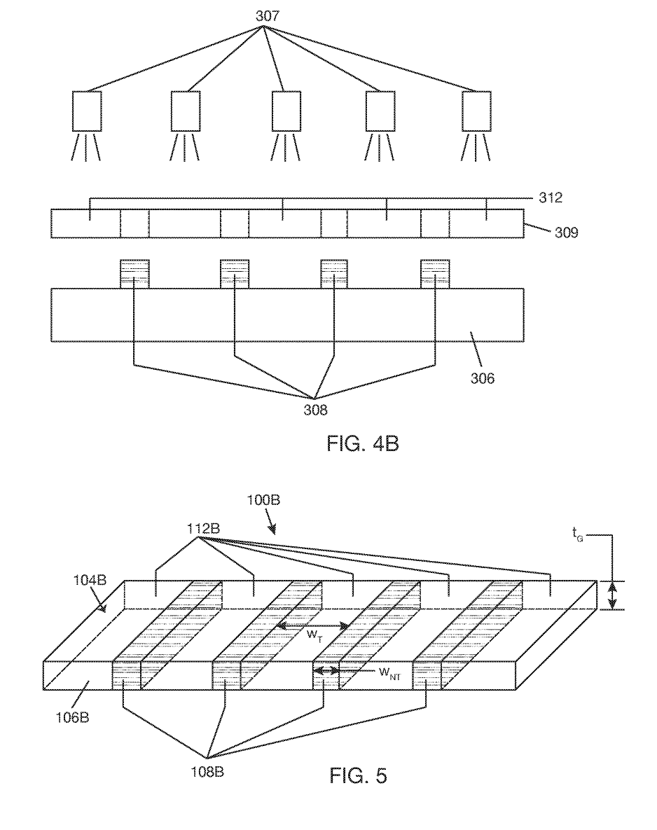

FIGS. 4A and 4B show a method of making the privacy filter 100A according to one embodiment. In FIG. 4A, the method includes depositing an ink layer 302 on a surface 305 of a transparent substrate 306. In one embodiment, the ink layer 302 is made of a thermally-curable ink. In one particular embodiment, the ink layer 302 is made of a thermally-curable black ink. The ink layer 302 may be deposited by a screen printing process, followed by curing of the ink. Other methods capable of depositing a uniform layer of ink on the substrate 306 may be used instead of screen printing. In FIG. 4B, the method includes forming a louver structure in the cured ink layer 302 by selective exposure of the cured ink layer 302 to radiation from, for example, UV or Green light sources 307 through a patterning mask 309. The areas of the cured ink layer 302 under openings 312 in the mask 309 will be etched away, forming the transparent channel elements or spaces (corresponding to 112A in FIG. 3) of the louver structure. The areas 308 of the cured ink layer 302 not exposed to the radiation will provide the non-transparent strip elements (corresponding to 108A in FIG. 3) of the louver structure 104A. Selecting the ink to be thermally-curable allows the use of actinic radiation for etching of the cured ink layer. It may also be possible that the ink layer 302 may be made of an ink that can be cured with a first type of radiation (i.e., a radiation-curable ink layer), and that a second type of radiation may be used for the selective etching of the radiation-cured ink layer.

FIG. 5 shows a privacy filter 100B according to another embodiment. The privacy filter 100B includes a louver structure 104B embedded in a photosensitive substrate 106B. The louver structure 104B includes a plurality of non-transparent strip elements 108B and a plurality of transparent strip elements 112B in parallel alternating arrangement. The non-transparent strip elements 108B are provided by non-transparent (colored, translucent, or opaque) strip areas of the photosensitive substrate 106B, and the transparent strip elements 112B are provided by transparent (clear) strips areas of the photosensitive substrate 106B. The thickness t_{G} of the photosensitive substrate 106B may be in a range from about 0.1 mm to about 2.0 mm. The height of each strip element 108B, 112B will be limited by the thickness of the t_{G} of the photosensitive substrate 106B. In one embodiment, the height of each strip element 108B, 112B will be the same as the thickness of the photosensitive substrate. As in the foregoing louver structures (104, 104A), the width w_{NT} of each non-transparent strip element 108B may be in a range from 1 μm to 30 μm, and the width W_{T} of each transparent strip element 112B may be in a range from 50 μm to 150 μm. The thickness of the photosensitive substrate 106B, the widths of the non-transparent strip elements 108B and transparent strip elements 112B, and the properties of the photosensitive substrate 106B can be selected to achieve a desired viewing angle and aperture ratio of the privacy filter as described for the previous privacy filters.

In one embodiment, the photosensitive substrate 106B is a photosensitive glass. A photosensitive glass is a glass that upon exposure to sufficient short wave radiation, such as ultraviolet radiation, develops coloration in the exposed areas while the unexposed areas remain unchanged. If the photosensitive glass starts out as a transparent glass, the areas with heat-developed coloration will be non-transparent, while the areas without heat-developed coloration will remain transparent U.S. Pat. No. 2,515,936 (Armistead, Jr., 1950) describes a photosensitive glass produced by incorporating silver chloride or silver halide into a silicate glass. This glass is capable of developing a yellow or amber color with UV light exposure. U.S. Pat. No. 3,208,860 (Armistead, Jr., 1965) discloses another example of a photosensitive glass produced by forming microcrystals of at least one silver halide selected from silver chloride, silver bromide, and silver iodide in a silicate glass.

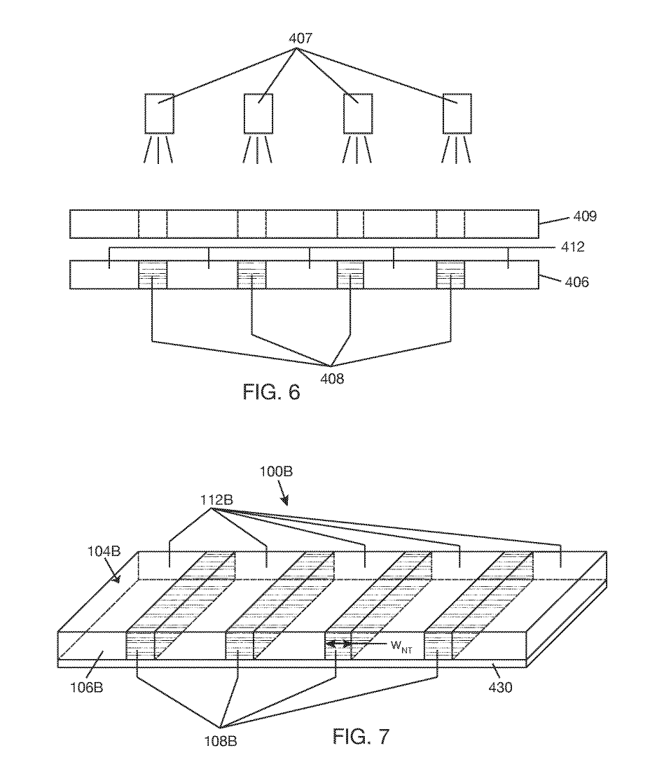

FIG. 6 shows a method of making the privacy filter 100B according to one embodiment. The method includes forming a louver structure in a photosensitive substrate 406 by selective exposure of the photosensitive substrate 406 to radiation from a UV light source 407 through a patterning mask 409. The exposed areas 408 of the photosensitive substrate having heat developed coloration will provide the non-transparent strip elements (corresponding to 108B in FIG. 5) of the louver structure. The unexposed areas 412 of the photosensitive substrate not having heat developed coloration will provide the transparent strip elements (corresponding to 112B in FIG. 5) of the louver structure.

Any of the privacy filters 100, 100A, 100B described above can be provided with means for attaching it to a surface. FIG. 7 shows one example where an optically-clear pressure-sensitive adhesive film 430 is attached to one side to the privacy filter 100B. The adhesive film 430 can be used to mount the privacy filter 100B on a screen, window, or other desired surface. Adhesive film can be similarly attached to the other filters 100, 100A described above.

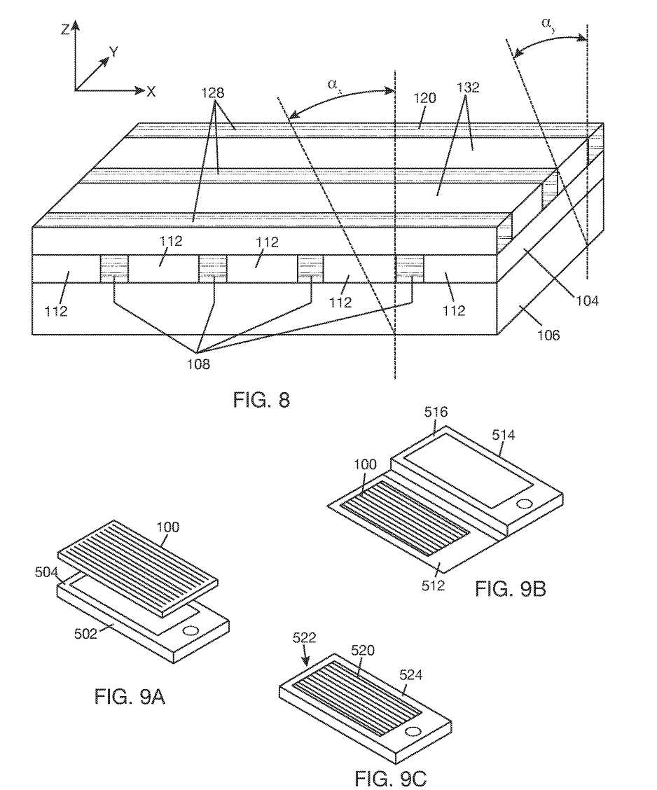

Two of any of the louver structures described above can be stacked, with their louver directions orthogonally aligned, to provide privacy filtering function in two orthogonal directions. This is illustrated in FIG. 8, where a second louver structure 120 is formed on the previous louver structure 104 on the transparent substrate 106. The non-transparent strip elements 128 and transparent strip elements 132 of the louver structure 120 are oriented along the X-axis, while the non-transparent strip elements 108 and transparent strip elements 112 of the louver structure 104 are oriented along the Y axis. The viewing angle of the first louver structure 104 is illustrated by αₓ, and the viewing angle of the second louver structure 120 is illustrated by α_{y}, where the meaning of viewing angle is as previously described. Another alternative is to locate the two louver structures on opposite sides of the transparent substrate, with the louver directions of the two louver structures being orthogonal to each other.

Privacy Filters as described above can be used in various applications, such as in screen protector for electronic devices, in touch panels, and in architectural material. FIG. 9A shows one application where the privacy filter 100 (or 100A, 100B) may be used as an add-on glass protector for a handheld device 502. The privacy filter 100 (or 100A, 100B) may be attached to the front surface 504 of the handheld device by means of an optically clear adhesive. FIG. 9B shows another application where the privacy filter 100 (or 100A, 100B) is integrated into a case 512, such as a leather case, for a handheld device 514. When the case 512 is closed, the privacy filter 100 (or 100A, 100B) will cover the front surface 516 of the handheld device 514.

Privacy filters as described above may also be used as cover glass for handheld devices. FIG. 9C shows a privacy filter cover glass 520, which may incorporate any of the previously described privacy filters 100, 100A, 100B, for a handheld device 522. The privacy filter cover glass 520 may be attached to the handheld device 522 using any suitable means known in the art, such as with a bezel 524. A touch module (not shown) may be attached underneath the privacy filter cover glass 520 to enable touch functionality of the handheld device 522.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A privacy filter, comprising:
a transparent substrate;
a louver structure formed in a layer on the transparent substrate, the louver structure comprising a plurality of non-transparent strip elements and a plurality of transparent strip elements in an alternating arrangement on the transparent substrate, the non-transparent strip elements being made of a non-transparent thermally irreversible photochromic polymer and the transparent strip elements being made of a transparent thermally irreversible photochromic polymer.

2. The privacy filter of claim 1, wherein the transparent substrate has a thickness in a range from 0.1 mm to 2 mm.

3. The privacy filter of claim 1, wherein each of the strip elements has a height in a range from 10 microns to 200 microns.

4. The privacy filter of claim 1, wherein each of the non-transparent strip elements has a width in a range from 1 micron to 30 microns.

5. The privacy filter of claim 4, wherein each of the transparent strip elements has a width in a range from 50 microns to 150 microns.

6. The privacy filter of claim 1, wherein an aperture ratio of the louver structure is 50% or greater.

7. The privacy filter of claim 1, further comprising another louver structure in stacked arrangement relative to the previous louver structure, the another louver structure having a louver direction orthogonal to a louver direction of the previous louver structure.

8. The privacy filter of claim 1, wherein the transparent substrate is glass.

9. The privacy filter of claim 8, wherein the glass is chemically-strengthened.

10. A method of making a privacy filter, comprising:
forming a transparent thermally irreversible photochromic polymer layer on a surface of a glass substrate; and
irradiating the transparent thermally irreversible photochromic polymer layer through a patterned mask to form an alternating arrangement of irradiated strips and non-irradiated strips of the transparent thermally irreversible photochromic polymer layer, wherein the irradiated strips become irreversibly non-transparent after the irradiating.

11. A privacy filter, comprising:
a transparent substrate; and
a louver structure formed in a layer on the transparent substrate, the louver structure comprising a plurality of parallel, spaced-apart non-transparent strip elements, each non-transparent strip element being made of cured ink.

12. The privacy filter of claim 11, wherein the transparent substrate is glass.

13. The privacy filter of claim 12, wherein the glass is chemically strengthened.

14. The privacy filter of claim 11, wherein a thickness of the transparent substrate is in a range from 0.1 mm to 2 mm.

15. The privacy filter of claim 11, wherein a width of each non-transparent strip element is in a range from 1 micron to 30 microns, and wherein a spacing between each adjacent pair of non-transparent strip elements is in a range from 50 microns to 150 microns.

16. A method of making a privacy filter, comprising:
forming a curable ink layer on a surface of a transparent substrate;
curing the curable ink layer to form a cured ink layer on the surface of the transparent substrate; and
irradiating the cured ink layer through a patterned mask to selectively etch the cured ink layer, thereby forming an alternating arrangement of non-transparent strip areas composed of cured ink and transparent channel areas free of cured ink.

17. The method of claim 16, wherein the curable ink layer is a thermally-curable ink layer, and wherein curing the curable ink layer comprises thermally curing the curable ink layer.

18. A privacy filter, comprising:
a photosensitive substrate having a louver structure embedded therein, the louver structure being defined by an alternating arrangement of a plurality of non-transparent strip areas and a plurality of transparent strip areas of the photosensitive substrate.

19. The privacy filter of claim 18, wherein the photosensitive substrate is a photosensitive glass.

20. The privacy filter of claim 19, wherein the photosensitive glass comprises a silicate glass containing at least one silver halide.

21. The privacy filter of claim 19, wherein the non-transparent strip sections are photo-induced in the photosensitive glass.

22. The privacy filter of claim 18, wherein a thickness of the photosensitive substrate is in a range from 0.1 mm to 2 mm.

23. The privacy filter of claim 18, wherein a width of each non-transparent strip area is in a range from 1 micron to 30 microns, and wherein a width of each transparent area is in a range from 50 microns to 150 microns.

24. A method of making a privacy filter, comprising:
irradiating a photosensitive glass through a patterned mask to induce heat-developed coloration in select areas of the photosensitive glass, thereby forming an alternative arrangement of non-transparent strip areas with the heat-developed coloration and transparent strip areas without the heat-developed coloration.

25. An electronic device comprising the privacy filter of claim 1.
